(19) United States
(12) Patent Application Publication
(10) Pub. No.: US 2024/0093415 A1
(43) Pub. Date: Mar. 21, 2024

(54) NON-WOVEN FABRIC CONTAINING POLYPROPYLENE FIBERS

(71) Applicant: Borealis AG, Vienna (AT)

(72) Inventors: Jingbo Wang, Linz (AT); Markus GAHLEITNER, Linz (AT); Pauli LESKINEN, Porvoo (FI); Klaus BERNREITNER, Linz (AT); Mathias HOFF, Linz (AT); Henk VAN PARIDON, Averbode (BE); Gustaf TOBIESON, Stenungsund (SE)

(73) Assignee: Borealis AG, Vienna (AT)

(21) Appl. No.: 17/927,569

(22) PCT Filed: May 26, 2021
(86) PCT No.: PCT/EP2021/064047

§ 371 Date: Nov. 23, 2022

(30) Foreign Application Priority Data
May 27, 2020 (EP) 20176797.7

(51) Int. Cl. D04H 3/007; C08F 110/06; C08L 23/12; D04H 3/03; D04H 3/16

(52) U.S. Cl. CPC D04H 3/007; C08F 110/06; C08L 23/12; D04H 3/03; D04H 3/16; C08L 2203/12; C08L 2205/02; D10B 2321/022; D10B 2401/04

(57) ABSTRACT

The present invention relates to a non-woven fabric comprising fibers which comprise a polypropylene composition comprising a polypropylene having
a melt flow rate MFR₂ (230° C./2.16 kg) measured according to ISO 1133 of 10 to 40 g/10 min,
a melting temperature Tₘ as determined by DSC according to ISO 11357 of >152.0° C. to <162.0° C., and
a number of 2,1 and 3,1 regio defects as measured by ¹³C NMR of from 0.01 to 0.85%,
   to a process for producing the non-woven fabric, to the use of said non-woven fabric for the production of an article and to an article comprising the non-woven fabric.

The present invention relates to a non-woven fabric with fibers which comprise a polypropylene composition comprising a polypropylene, to a process for producing a non-woven fabric wherein fibers are formed from the polypropylene composition and wherein the fibers are formed into the non-woven fabric, to the use of said non-woven fabric for the production of an article and to an article made of said non-woven fabric.

Products comprising non-woven fabrics are widely used in the daily life due to their advantageous cost/performance relation. A big part of these products are produced using polypropylene, especially propylene homopolymer, fibers. Such products include filtration media (filters), diapers, sanitary products, sanitary napkins, panty liners, incontinence products for adults, protective clothing materials, bandages, surgical drapes, surgical gowns, surgical wear and packing materials.

It is well known that polypropylene which is produced using a single-site catalyst has benefits for the application as fibers/non-woven fabrics compared to polypropylene produced with a Ziegler-Natta catalyst (see e.g. G. M. Benedikt & B. L. Goodall, Metallocene catalysed polymers, 1998, pp 315): Due to narrower MWD, the spinning is better and, therefore, finer fibers with improved mechanical properties can be achieved.

For example, EP 2 245 221 A1 discloses fibers which comprise polypropylene produced with a metallocene catalyst, which has a molecular weight distribution (Mw/Mn) of at least 3.

However, there is still the need for non-wovens with improved properties such as mechanical properties, e.g. it is desirable to produce polypropylene fibers which allow to produce non-wovens with still a higher force and elongation at break, as this does not only help to provide light weight products but also prolongs the life time of the finished products, helping to protect the environment.

The present invention provides a non-woven fabric comprising, or consisting of, fibers which comprise, or consist of, a polypropylene composition comprising, or consisting of, a polypropylene having
a melt flow rate MFR₂ (230° C./2.16 kg) measured according to ISO 1133 of 10 to 40 g/10 min,
a melting temperature Tₘ as determined by DSC according to ISO 11357 of >152.0° C. to <162.0° C., and
a number of 2,1 and 3,1 regio defects as measured by ¹³C NMR of from 0.01 to 0.85%.

The non-woven fabrics of the invention have improved mechanical properties over non-woven fabrics comprising polypropylene of the prior art. In particular, the non-woven fabrics of the invention have increased force and a higher elongation at break, allowing for the production of lighter and more durable products.

Preferably, the polypropylene composition does not contain any visbroken materials. Thus, in particular preferably the polypropylene is not a visbroken material.

Furthermore, preferably, the polypropylene is a propylene homopolymer, i.e. preferably it consists of propylene monomer units and up to 1 wt. % of other olefin monomers such as ethylene, more preferably it consists of propylene monomer units and up to 0.5 wt. % of other olefin monomers such as ethylene, and most preferably it consists of propylene monomer units.

The catalyst used for producing the polypropylene influences in particular the microstructure of the polymer. Accordingly, polypropylenes prepared by using a metallocene catalyst provide a different microstructure compared to those prepared by using Ziegler-Natta (ZN) catalysts. The most significant difference is the presence of regio-defects in metallocene-made polypropylenes which is not the case for polypropylenes made by Ziegler-Natta (ZN) catalysts.

The regio-defects of propylene polymers can be of three different types, namely 2,1-erythro (2,le), 2,1-threo (2,lt) and 3,1 defects. A detailed description of the structure and mechanism of formation of regio defects in polypropylene can be found in Chemical Reviews 2000, 100(4), pages 1316-1327. These defects are measured using ¹³C NMR as described in more detail below.

The term “2,1 regio defects” as used in the present invention defines the sum of 2,1-erythro regio-defects and 2,1-threo regio defects.

Preferably, the number of 2,1 and 3,1 regio defects in the polypropylene is from 0.45 to 0.80 mol % as measured by ¹³C NMR.

Polypropylenes having a number of regio defects as required in the propylene composition to be used to produce the non-woven of the invention are usually and preferably prepared in the presence of a single-site catalyst.

It is preferred that the polypropylene composition comprises at least 80 wt. % of the polypropylene, more preferably at least 90 wt. % of the polypropylene and most preferably the polypropylene is the only polymeric component present in the composition, i.e. the polypropylene composition consists of the polypropylene and, optionally, contains one or more additives such as described herein below. The amount of additives, if present, is usually 5 wt. % or less, preferably 3 wt. % or less.

The polypropylene preferably has a comparatively small molecular weight distribution as determined by GPC. Thus, preferably the polypropylene has a MWD of 2.0 to 4.5, more preferably of 2.5 to 4.5, and still more preferably of 2.7 to 4.0.

The melting temperature Tₘ as determined by DSC according to ISO 11357 of the polypropylene is preferably 153.0 to 157.0° C.

The polypropylene has preferably a melt flow rate MFR₂ (230° C./2.16 kg) measured according to ISO 1133 of 15 to 37 g/10 min, still more preferably of 20 to 35 g/10 min.

Still further, the polypropylene has the advantage of having only a low amount of hexane extractables. Thus, it is preferred that the polypropylene has a hexane extractables contents as measured according to the FDA test of less than 2.0 wt. %, more preferably of less than 1.5 wt. %.

In order to facilitate processing it is also desirable that the polypropylene has a suitable crystallization temperature even in absence of any nucleating agents.

Thus, preferably, the polypropylene has a crystallization temperature T_{c} as determined by DSC according to ISO 11357 in the range of 100 to 130° C., more preferably in the range of 105° C. to 125° C., like in the range of 110° C. to 120° C.

The polypropylene preferably has a xylene cold soluble (XCS) fraction as determined according to ISO 16152 of from 0.1 to below 4.0 wt. %, more preferably of from 0.1 to 2.5 wt. %, and most preferably of 0.2 to 2.0 wt. %.

Furthermore, the polypropylene preferably has a flexural modulus as determined according to ISO 178 on injection moulded specimens of 1200 to 1800 MPa, more preferably in the range of 1250 to 1650 MPa, and most ♦preferably in the range of 1300 to 1600 MPa.

Preferably, the polypropylene comprises, or consists of, two polymer fractions (PPH-1) and (PPH-2). The split between fractions (PPH-1) and (PPH-2) is preferably from 30:70 to 70:30, more preferably is from 45:55 to 65:35, and most preferably is from 55:45 to 60:40.

Optionally, a small fraction of prepolymer, which typically is a propylene homopolymer, in an amount of usually below 5 wt. %, may also be present in the polypropylene.

Furthermore, it is preferred that (PPH-1) has a melt flow rate MFR₂ (230° C./2.16 kg) measured according to ISO 1133 in the range of from 10 to 50 g/10 min, more preferably 15 to 40 g/10 min and most preferably 20 to 35 g/10 min, and/or that (PPH-2) has a melt flow rate MFR₂ (230° C./2.16 kg) measured according to ISO 1133 in the range of from 10 to 50 g/10 min, more preferably 15 to 40 g/10 min and most preferably 20 to 35 g/10 min.

Preferably, the polypropylene is produced in the presence of a metallocene catalyst, which is preferably a metallocene catalyst comprising a complex in any one of the embodiments as described in WO2013/007650, WO2015/158790 and WO2018/122134.

To form an active catalytic species it is normally necessary to employ a cocatalyst as is well known in the art. Cocatalysts comprising one or more compounds of Group 13 metals, like organoaluminium compounds or boron containing cocatalysts or combinations therefrom used to activate metallocene catalysts are suitable for use in this invention.

In a preferred embodiment of the present invention a cocatalyst system comprising a boron containing cocatalyst, e.g. a borate cocatalyst and an aluminoxane cocatalyst is used.

Suitable co-catalysts are described in WO2013/007650, WO2015/158790 and WO2018/122134 and it is preferred that a cocatalyst in any one of the embodiments as described therein is used.

The catalyst system used to manufacture the polypropylene is ideally provided in solid particulate form supported on an external carrier.

The particulate support material used is silica or a mixed oxide such as silica-alumina. The use of a silica support is preferred.

Especially preferably the support is a porous material so that the complex may be loaded into the pores of the particulate support, e.g. using a process analogous to those described in WO94/14856, WO95/12622 and WO2006/097497.

The preparation of the solid catalyst system is also described in WO2013/007650, WO2015/158790 and WO2018/122134 and it is preferred that the catalyst system is prepared according to any one of the embodiments described therein.

The polypropylene in any of its embodiments comprising two fractions (PPH-1) and (PPH-2) is preferably produced in a process comprising the following steps:
a) polymerizing in a first reactor (R1) propylene obtaining polymer fraction (PPH-1),
b) transferring said polymer fraction (PPH-1) and unreacted monomers of the first reactor in a second reactor (R2),
c) feeding to said second reactor (R2) propylene,
d) polymerizing in said second reactor (R2) and in the presence of said polymer fraction (PPH-1) propylene to obtain polymer fraction (PPH-2) in an intimate mixture with (PPH-1) and hence the final polypropylene,
whereby preferably the polymerization takes place in the presence of a metallocene catalyst system in any one of the embodiments as described herein.

The polypropylene is, therefore, preferably prepared by polymerizing propylene by a sequential polymerization process comprising, or consisting of, at least two reactors connected in series in the presence of a metallocene catalyst.

Each of the two polymerization stages can be carried out in solution, slurry, fluidized bed, bulk or gas phase.

The term “polymerization reactor” shall indicate that the main polymerization takes place therein. Thus in case the process consists of one or two polymerization reactors, this definition does not exclude the option that the overall system comprises for instance a pre-polymerization step in a pre-polymerization reactor. The term “consist of” is only a closing formulation in view of the main polymerization reactors.

The term “sequential polymerization process” indicates that the polypropylene is produced in at least two reactors connected in series. Accordingly, such a polymerization system comprises at least a first polymerization reactor (R1) and a second polymerization reactor (R2), and optionally a third polymerization reactor (R3).

The first polymerization reactor (R1) is preferably a slurry reactor and can be any continuous or simple stirred batch tank reactor or loop reactor operating in bulk or slurry. Bulk means a polymerization in a reaction medium that comprises of at least 60% (w/w) monomer. According to the present invention, the slurry reactor is preferably a (bulk) loop reactor.

The second polymerization reactor (R2) and the optional third polymerization reactor (R3) are preferably gas phase reactors (GPRs), i.e. a first gas phase reactor (GPR1) and a second gas phase reactor (GPR2). A gas phase reactor (GPR) according to this invention is preferably a fluidized bed reactor, a fast fluidized bed reactor or a settled bed reactor or any combination thereof.

A preferred multistage process is a “loop-gas phase”-process, such as developed by Borealis (known as BORSTAR® technology) described e.g. in patent literature, such as in EP 0 887 379, WO 92/12182, WO 2004/000899, WO 2004/111095, WO 99/24478, WO 99/24479 or in WO 00/68315.

A further suitable slurry-gas phase process is the Spheripol® process of Basel!.

Preferably, in the process for producing the polypropylene as defined above the conditions for the first reactor (R1), i.e. the slurry reactor (SR), like a loop reactor (LR), of step (a) may be as follows:
the temperature is within the range of 40° C. to 110° C., preferably between 60° C. and 100° C., more preferably between 65 and 95° C.,
the pressure is within the range of 20 bar to 80 bar, preferably between 40 bar to 70 bar,
hydrogen can be added for controlling the molar mass in a manner known per se.

Subsequently, the reaction mixture of the first reactor (R1) is transferred to the second reactor (R2), i.e. gas phase reactor (GPR1), where the conditions are preferably as follows:
the temperature is within the range of 50° C. to 130° C., preferably between 60° C. and 100° C.,
the pressure is within the range of 5 bar to 50 bar, preferably between 15 bar to 40 bar,
hydrogen can be added for controlling the molar mass in a manner known per se.

The polypropylene composition may comprise one or more usual additives, preferably in a total amount of from 0.01 up to 5.0 wt. %, more preferably from 0.05 to 3.0 wt. %, selected from the group comprising slip agents, anti-block agents, UV stabilizers, antistatic agents, alpha-nucleating agents and antioxidants.

Slip agents migrate to the surface and act as lubricants polymer to polymer and polymer against metal rollers, giving reduced coefficient of friction (CoF) as a result. Examples are fatty acid amids, like erucamide (CAS No. 112-84-5), oleamide (CAS No. 301-02-0), stearamide (CAS No. 124-26-5) or combinations thereof.

Examples of antioxidant are sterically hindered phenols (such as CAS No. 6683-19-8, also sold as Irganox 1010 FF™ by BASF), phosphorous based antioxidants (such as CAS No. 31570-04-4, also sold as Hostanox PAR 24 (FF)™ by Clariant, or Irgafos 168 (FF)™ by BASF), sulphur based antioxidants (such as CAS No. 693-36-7, sold as Irganox PS-802 FL™ by BASF), nitrogen-based antioxidants (such as 4,4′-bis(1,1′-dimethylbenzyl)diphenylamine), or antioxidant blends.

Examples for acid scavengers are calcium stearates, sodium stearates, zinc stearates, magnesium and zinc oxides, synthetic hydrotalcite (e.g. SHT, CAS No. 11097-59-9), lactates and lactylates, as well as calcium stearate (CAS No. 1592-23-0) and zinc stearate (CAS No. 557-05-1).

Common antiblocking agents are natural silica such as diatomaceous earth (such as CAS No. 60676-86-0 (SuperfFloss™), CAS No. 60676-86-0 (SuperFloss E™), or CAS No. 60676-86-0 (Celite 499™), synthetic silica (such as CAS No. 7631-86-9, CAS No. 7631-86-9, CAS No. 7631-86-9, CAS No. 7631-86-9, CAS No. 7631-86-9, CAS No. 7631-86-9, CAS No. 112926-00-8, CAS No. 7631-86-9, or CAS No. 7631-86-9), silicates (such as aluminium silicate (Kaolin) CAS No. 1318-74-7, sodium aluminum silicate CAS No. 1344-00-9, calcined kaolin CAS No. 92704-41-1, aluminum silicate CAS No. 1327-36-2, or calcium silicate CAS No. 1344-95-2), synthetic zeolites (such as sodium calcium aluminosilicate hydrate CAS No. 1344-01-0, CAS No. 1344-01-0, or sodium calcium aluminosilicate, hydrate CAS No. 1344-01-0)

Suitable UV-stabilisers are, for example, Bis-(2,2,6,6-tetramethyl-4-piperidyl)-sebacate (CAS No. 52829-07-9, Tinuvin 770); 2-hydroxy-4-n-octoxy-benzophenone (CAS No. 1843-05-6, Chimassorb 81).

Alpha nucleating agents like sodium benzoate (CAS No. 532-32-1); a mixture of aluminium-hydroxy-bis[2,2′-methylene-bis(4,6-di-t-butylphenyl)phosphate] and lithium myristate (commercially available as Adekastab NA-21 of Adeka Palmarole, France) or 1,3:2,4-bis(3,4-dimethylbenzylidene)sorbitol (CAS No. 135861-56-2, commercially available as Milled 3988 of Milliken, USA) can also be added.

Suitable antistatic agents are, for example, glycerol esters (CAS No. 97593-29-8) or ethoxylated amines (CAS No. 71786-60-2 or 61791-31-9) or ethoxylated amides (CAS No. 204-393-1).

Usually these additives are added in quantities of 100-1.000 ppm for each single component.

Preferably at least an antioxidant is added to the composition of the invention.

In one preferred embodiment of the present invention, the polypropylene fibers used for producing the non-woven fabric have an average filament fineness of not more than 2.0 denier and more preferably of not more than 1.9 denier.

Preferably, the polypropylene fibers have an average filament fineness greater than 0.2 denier, more preferably of greater than 0.3 denier.

The fiber fineness may for example be in the range of 0.5 to 1.6 denier.

The present invention further relates to a process for producing a non-woven fabric wherein fibers are formed from a polypropylene composition in any one of the above disclosed embodiments and wherein the fibers are formed into the non-woven fabric.

This process preferably is a spunbonding process.

Further preferred, the process includes spunbonding wherein the polypropylene composition in any of the above disclosed embodiments by using a fiber spinning line at a maximum cabin air pressure of at least 3,000 Pa, preferably of at least 4,000 Pa and more preferably of at least 5,000 Pa. The cabin air pressure can be up to 10,000 Pa, preferably up to 9,000 Pa.

The spun bonding process is one which is well known in the art of fabric production. In general, continuous fibers are extruded, laid on an endless belt, and then bonded to each other, and often times to a second layer such as a melt blown layer, often by a heated calender roll, or addition of a binder, or by a mechanical bonding system (entanglement) using needles or hydro jets.

A typical spunbonding process consists of a continuous filament extrusion, followed by drawing, web formation by the use of some type of ejector, and bonding of the web. First, pellets or granules of the polypropylene composition as defined above are fed into an extruder. In the extruder, the pellets or granules are melted and forced through the system by a heating melting screw. At the end of the screw, a spinning pump meters the molten polymer through a filter to a spinneret where the molten polymer is extruded under pressure through capillaries, at a rate of 0.3 to 1.0 grams per hole per minute.

The spinneret contains between 65 and 75 holes per cm, measuring 0.4 mm to 0.7 mm in diameter. The polypropylene homopolymer is melted at about 30° C. to 150° C. above its melting point to achieve sufficiently low melt viscosity for extrusion. The fibers exiting the spinneret are quenched and drawn into fine fibers measuring at most 20 microns in diameter by cold air jets, reaching filament speeds of at least 2,500 m/min. The solidified fiber is laid randomly on a moving belt to form a random netlike structure known in the art as web. After web formation the web is bonded to achieve its final strength using a heated textile calender known in the art as thermobonding calender. The calender consists of two heated steel rolls; one roll is plain and the other bears a pattern of raised points. The web is conveyed to the calender wherein a fabric is formed by pressing the web between the rolls at a bonding temperature of about 140° C. to 160° C.

The non-woven of the invention preferably has an area weight of 5 to 150 g/m², more preferably of 10 to 100 g/m².

The present invention further relates to the use of a non-woven fabric according to any one of above described embodiments for the production of an article.

Still further, the present invention relates to an article comprising the non-woven fabric according to any one of above described embodiments.

Preferably, the article comprises or is a filtration medium (filter), diaper, sanitary napkin, panty liner, incontinence product for adults, protective clothing, surgical drape, surgical gown, and/or surgical wear.

Unless explicitly described otherwise, the description of the present invention is to be understood so that one or more of any of the above described preferred embodiments of the non-woven fabric of the invention can be combined with the invention described in its most general features.

In the following, the measurement and determination methods for the parameters as used herein are given and the present invention is further illustrated by way of example and comparative example by reference to the figures, which show:

### Measurement and Determination Methods

### a) Measurement of Melt Flow Rate MFR₂

MFR₂ (230° C.) is measured according to ISO 1133 (230° C., 2.16 kg load).

### b) Calculation of Melt Flow Rate MFR₂ of the Polymer Fraction PPH-2:

$$MFR ( A 2 ) = {10}^{[ \frac{log ( MFR ( A ) ) - w ( A 1 ) \times log ( MFR ( A 1 ) )}{w ( A 2 )} ]} \qquad ( II )$$

wherein
w(A1) is the weight fraction [in wt %] of the polymer fraction PPH-1
w(A2) is the weight fraction [in wt %] of the polymer fraction PPH-2,
MFR(A1) is the melt flow rate MFR₂ (230° C.) [g/10 min] of the polymer fraction PPH-1,
MFR(A) is the melt flow rate MFR₂ (230° C.) [g/10 min] of the entire polypropylene (PPH),
MFR(A2) is the calculated melt flow rate MFR₂ (230° C.) [g/10 min] of the polymer fraction PPH-2.

### c) Quantification of Microstructure by NMR Spectroscopy

Quantitative nuclear-magnetic resonance (NMR) spectroscopy was further used to quantify the comonomer content and comonomer sequence distribution of the polymers. Quantitative ¹³C{¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimized 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatary oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimized tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6 k) transients were acquired per spectra.

Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

With characteristic signals corresponding to 2,1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required. Characteristic signals corresponding to other types of regio defects were not observed.

The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

E=0.5(Sββ+Sβγ+Sβδ+0.5(Sαβ+Sαγ))

Through the use of this set of sites the corresponding integral equation becomes:

E=0.5(I_{H}+I_{G}+0.5(I_{C}+I_{D}))

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

E [mol %]=100*fE

The weight percent comonomer incorporation was calculated from the mole fraction:

E [wt %]=100*(fE*28.06)/((fE*28.06)+((1−fE)*42.08))

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

### d) Xylene Solubles (XCS, wt. %):

The xylene soluble (XS) fraction as defined and described in the present invention was determined in line with ISO 16152 as follows: 2.0 g of the polymer were dissolved in 250 ml p-xylene at 135° C. under agitation. After 30 minutes, the solution was allowed to cool for 15 minutes at ambient temperature and then allowed to settle for 30 minutes at 25+/−0.5° C. The solution was filtered with filter paper into two 100 ml flasks. The solution from the first 100 ml vessel was evaporated in nitrogen flow and the residue dried under vacuum at 90° C. until constant weight is reached. The xylene soluble fraction (percent) can then be determined as follows:

XS %=(100*m*V0)/(m0*v),
m0=initial polymer amount (g);
m=weight of residue (g);
V0=initial volume (ml);
v=volume of analyzed sample (ml).

### e) DSC Analysis, Melting (Tm) and Crystallization Temperature (Tc):

Data were measured with a TA Instrument Q2000 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C.

Crystallization temperature (T_{c}) and crystallization enthalpy (H_{c}) are determined from the cooling step, while melting temperature (Tₘ) and melting enthalpy (Hₘ) are determined from the second heating step.

### f) Flexural Modulus

Flexural modulus is determined according to ISO 178 on 80×10×4 mm³ test bars injection moulded in line with EN ISO 1873-2.

### g) Hexane Extractables

The hexane extractable fraction is determined according to FDA method (federal registration, title 21, Chapter 1, part 177, section 1520, s. Annex B) on cast films of 100 μm thickness produced on a monolayer cast film line with a melt temperature of 220° C. and a chill roll temperature of 20° C. The extraction was performed at a temperature of 50° C. and an extraction time of 30 min.

### h) Molecular Weight Properties

Number average molecular weight (Mn), weight average molecular weight (Mw) and polydispersity (Mw/Mn) were determined by Gel Permeation Chromatography (GPC) according to the following method:

The weight average molecular weight Mw and the polydispersity (Mw/Mn), wherein Mn is the number average molecular weight and Mw is the weight average molecular weight) is measured by a method based on ISO 16014-1:2003 and ISO 16014-4:2003. A Waters Alliance GPCV 2000 instrument, equipped with refractive index detector and online viscosimeter was used with 3×TSK-gel columns (GMHXL-HT) from TosoHaas and 1,2,4-trichlorobenzene (TCB, stabilized with 200 mg/L 2,6-Di tert butyl-4-methyl-phenol) as solvent at 145° C. and ata constant flow rate of 1 mL/min. 216.5 μl of sample solution were injected per analysis. The column set was calibrated using relative calibration with 19 narrow MWD polystyrene (PS) standards in the range of 0.5 kg/mol to 11 500 kg/mol and a set of well characterized broad polypropylene standards. All samples were prepared by dissolving 5-10 mg of polymer in 10 mL (at 160° C.) of stabilized TCB (same as mobile phase) and keeping for 3 hours with continuous shaking prior sampling in into the GPC instrument.

### i) Mechanical Properties

The mechanical properties of the webs were determined in accordance with EN 29073-3 (1989), “Test methods for nonwovens—Determination of tensile strength and elongation”. The parameters were determined in both of cross direction (CD) and machinery direction (MD), on spunbonded webs having an area weight in the range of 5 to 50 g/m². The VD is perpendicular to processing direction and MD is parallel to processing direction.

### j) Filament Fineness

The filament fineness in denier has been calculated from the average fiber diameter by using the following correlation:

Fiber diameter (in cm)=(4.444×10-6×denier/0.91×ττ)½

### k) Grammage of the Non-Woven

The unit weight (grammage) of the webs in g/m² was determined in accordance with ISO 536:1995.

### l) Fiber Diameter

The fiber diameter was detected by using optical microscope. 200 fibers were measured and the average is reported.

### EXAMPLES

A polypropylene for producing a non-woven fabric in accordance with the invention (Inventive Examples, IE), using a single-site metallocene catalyst was prepared as follows:

### Catalyst System IE

### Metallocene (MC1) (rac-anti-dimethylsilandiyl(2-methyl-4-phenyl-5-methoxy-6-tert-butyl-indenyl)(2-methyl-4-(4-tert-butylphenypindenyl)zirconium dichloride)

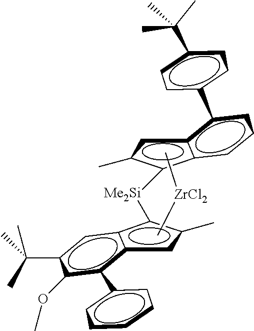

was synthesized according to the procedure as described in WO 2013/007650, E2.

A MAO-silica support was prepared as follows: A steel reactor equipped with a mechanical stirrer and a filter net was flushed with nitrogen and the reactor temperature was set to 20° C. Next silica grade DM-L-303 from AGC Si-Tech Co, pre-calcined at 600° C. (7.4 kg) was added from a feeding drum followed by careful pressuring and depressurising with nitrogen using manual valves. Then toluene (32 kg) was added. The mixture was stirred for 15 min. Next 30 wt. % solution of MAO in toluene (17.5 kg) from Lanxess was added via feed line on the top of the reactor within 70 min. The reaction mixture was then heated up to 90° C. and stirred at 90° C. for additional two hours. The slurry was allowed to settle and the mother liquor was filtered off. The MAO treated support was washed twice with toluene (32 kg) at 90° C., following by settling and filtration. The reactor was cooled off to 60° C. and the solid was washed with heptane (32.2 kg). Finally MAO treated SiO2 was dried at 60° under nitrogen flow for 2 hours and then for 5 hours under vacuum (−0.5 barg) with stirring. MAO treated support was collected as a free-flowing white powder found to contain 12.6% Al by weight.

The final catalyst system was prepared as follows: 30 wt. % MAO in toluene (2.2 kg) was added into a steel nitrogen blanked reactor via a burette at 20° C. Toluene (7 kg) was then added under stirring. Metallocene MC1 (286 g) was added from a metal cylinder followed by flushing with 1 kg toluene. The mixture was stirred for 60 minutes at 20° C. Trityl tetrakis(pentafluorophenyl) borate (336 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under N2 flow at 60° C. for 2 h and additionally for 5 h under vacuum (−0.5 barg) under stirring. Dried catalyst was sampled in the form of pink free flowing powder containing 13.9 wt % Al and 0.26 wt % Zr.

The polymerization for preparing the polypropylene of the inventive examples was performed in a Borstar pilot plant with a 2-reactor set-up (loop—gas phase reactor (GPR 1)) and a pre-polymerizer, using the catalyst system as described above.

For the production of a comparative non-woven fabric (Comparative Example 1 (CE1)) commercially available resin Lumicene MR2001 was used. In Table 1, the polymerization conditions for the resin of the inventive examples IE and the final properties of the resins of the inventive examples and CE1 are given.

TABLE 1

| | | IE | CE1 |
|---|---|---|---|
| Prepolymerizer | | | |
| Temperature | ° C. | 25 | |
| Pressure | kPa | 5153 | |
| Loop | | | |
| Temperature | ° C. | 75 | |
| Pressure | kPa | 5400 | |
| Feed H2/C3 | mol/kmol | 0.48 | |
| Split | wt % | 62 | |
| MFR | g/10 min | 26.2 | |
| GPR1 | | | |
| Temperature | ° C. | 80 | |
| H2/C3 | mol/kmol | 3 | |
| Split | wt % | 38 | |
| MFR (final PP) | g/10 min | 27 | |
| Final polymer | | | |
| MFR | g/10 min | 27 | 25 |
| XCS | wt % | 0.9 | |
| Tm | | 153 | 151 |
| Tc | | 115 | |
| 2, 1e | mol % | 0.7 | |
| 2, 1t | mol % | 0 | |
| 3, 1 | mol % | 0 | |
| FM | MPa | 1450 | 1300 |
| MWD | | 3.4 | |

The polymer powders were compounded in a co-rotating twin-screw extruder Coperion ZSK 57 at 220° C. 0.1 wt % antioxidant (Irgafos 168FF); 0.1 wt % of a sterically hindered phenol (Irganox 1010FF), 0.05 wt % of Ca-stearat).

Using the compounded resin of the inventive examples and of CE1 as described above, polypropylene fibers and spunbonded fabrics were produced as follows:

The polypropylene homopolymers were converted into spunbonded fabrics on a Reicofil 4 line using a spinneret having 7377 holes of 0.6 mm exit diameter and 6827 holes per meter. The details of the process are in Table 2. The product is fixed as 10 g/m². The properties are also shown in Table 2.

TABLE 2

| | | | Extruder | | | | | | | | | |
|---|---|---|---|---|---|---|---|---|---|---|---|---|
| | | | | | melt | | | Cabin | | calander | | |
| | | | | Die | temper- | melt | | cabin | monomer | | | engraved/ |
| | throughput | line | Extruder | temper- | ature | pressure | pressure | pressure | extraction | draw | nip | smooth |
| | per hole | speed | temper- | ature | die | die | extruder | (SET) | (SET) | S-roll | pressure | roll temp. |
| | [g/min*hole] | [m/min] | ature[° C.] | [° C.] | [° C.] | [bar] | [bar] | [Pa] | [%] | [%] | [N/mm] | (oil) [° C.] |
| IE1 | 0.54 | 355.0 | 245 | 250 | 244 | 66 | 79 | 4500 | 11 | 4.0 | 80 | 147 |
| IE2 | 0.54 | 355.0 | 245 | 250 | 244 | 66 | 79 | 4500 | 11 | 4.0 | 80 | 152 |
| IE3 | 0.54 | 355.0 | 245 | 250 | 244 | 66 | 79 | 5500 | 9 | 4.0 | 80 | 152 |
| IE4 | 0.42 | 282.0 | 275 | 280 | 270 | 45 | 73 | 4500 | 12 | 3.0 | 80 | 152 |
| CE1 | 0.54 | 355.0 | 245 | 250 | 243 | 71 | 80 | 4500 | 12 | 4.0 | 80 | 152 |

| | calander | | | | | | | | | | |
|---|---|---|---|---|---|---|---|---|---|---|---|
| | HOT- | engr./ | HOT- | measured data | | | | | | | |
| | S-roll | smooth | S-roll | | | filament | tensile | tensile | | | |
| | temp. | roll | surface | filament | filament | diameter | strength | strength | elongation | elongation | fabric |
| | (oil) | surface | temp. | fineness | fineness | [μm] - | MD | CD | MD | CD | weight |
| | [° C.] | temp. [° C.] | [° C.] | [dtex] | [den] | Filament | [N] | [N] | [%] | [%] | [gsm] |
| IE1 | 145 | 135 | 134 | 1.55 | 1.4 | 14.75 | 22.5 | 12.8 | 87.8 | 98.2 | 10.1 |
| IE2 | 150 | 139 | 139 | 1.55 | 1.4 | 14.75 | 22.7 | 12.9 | 88.8 | 87.1 | 9.8 |
| IE3 | 150 | 139 | 138 | 1.55 | 1.39 | 14.72 | 23.8 | 12.5 | 72.2 | 85.4 | 9.7 |
| IE4 | 150 | 140 | 138 | 1.28 | 1.15 | 13.37 | 25.7 | 14.3 | 80.3 | 97.3 | 10.3 |
| CE1 | 150 | 139 | 138 | 1.7 | 1.53 | 15.41 | 20.9 | 10.3 | 69.1 | 70.9 | 9.9 |

As can be seen, the non-woven fabric of the invention comprise fibers which are significantly finer than those of the comparative non-woven fabric, therefore the mechanical properties (force and elongation) are improved, especially along the CD direction.

1. A non-woven fabric comprising fibers which comprise a polypropylene composition comprising a polypropylene having
a melt flow rate MFR₂ (230° C./2.16 kg) measured according to ISO 1133 of 10 to 40 g/10 min,
a melting temperature Tm as determined by DSC according to ISO 11357 of >152.0° C. to <162.0° C., and
a number of 2.1 and 3.1 regio defects as measured by ¹³C NMR of from 0.01 to 0.85%.

2. Non-woven fabric according to claim 1 wherein the polypropylene is a propylene homopolymer.

3. Non-woven fabric according to claim 1 wherein the polypropylene has a molecular weight distribution MWD of 2 to 4.5 as determined by GPC.

4. Non-woven fabric according to claim 1 wherein the polypropylene has a melting Tₘ of 153.0 to 157.0° C.

5. Non-woven fabric according to claim 1 wherein the polypropylene has been produced in the presence of a single-site catalyst.

6. Non-woven fabric according to claim 1 wherein the polypropylene has a xylene cold soluble (XCS) fraction as determined according to ISO 16152 of from 0.1 to below 4 wt. %.

7. Non-woven fabric according to claim 1 wherein the polypropylene has a xylene cold soluble (XCS) fraction as determined according to ISO 16152 of from 0.1 to 2.5 wt. %.

8. Non-woven fabric according to claim 1 wherein the polypropylene has a melt flow rate MFR₂ of 20 to 35 g/10 min.

9. Non-woven fabric according to claim 1 wherein the polypropylene comprises, or consists of, two polymer fractions (PPH-1) and (PPH-2) with the split between fractions (PPH-1) and (PPH-2) is from 30:70 to 70:30.

10. Non-woven fabric according to claim 1 wherein the polypropylene has a crystallization temperature T_{c} as determined by DSC according to ISO 11357 in the range of 100 to 135° C.

11. Non-woven fabric according to claim 1 wherein the polypropylene has a flexural modulus as determined according to ISO 178 on injection moulded specimens of 1200 to 1800 MPa.

12. A process for producing a non-woven fabric wherein fibers are formed from a polypropylene composition comprising a polypropylene having
a melt flow rate MFR₂ (230° C./2.16 kg) measured according to ISO 1133 of 10 to 40 g/10 min,
a melting temperature Tₘ as determined by DSC according to ISO 11357 of >152.0° C. to <162.0° C., and
a number of 2,1 and 3,1 regio defects as measured by ¹³C NMR of from 0.01 to 0.85%,
and wherein the fibers are formed into the non-woven fabric.

13. A production process of an article comprising non-woven fabric.

14. An article comprising the non-woven fabric according to claim 1.

15. The process of claim 13, wherein the article comprises a filtration medium (filter), diaper, sanitary napkin, panty liner, incontinence product for adults, protective clothing, surgical drape, surgical gown, and/or surgical wear.

16. The article of claim 13, wherein the article comprises a filtration medium (filter), diaper, sanitary napkin, panty liner, incontinence product for adults, protective clothing, surgical drape, surgical gown, and/or surgical wear.
